(19) United States
(12) Patent Application Publication
(10) Pub. No.: US 2005/0056124 A1
(43) Pub. Date: Mar. 17, 2005

(54) Filter cap having a gripping surface

(76) Inventors: Gary B. Zulauf, Findlay, OH (US); Michael S. Lynch, Fostoria, OH (US); Russel Shaw, Pietermaritzburg (ZA); Ravindra Balachandran Naidoo, Pietermaritzburg (ZA)

Correspondence Address: Honeywell International Inc., 101 Columbia Road, P.O. Box 2245, Morristown, NJ, 07962, US

(21) Appl. No.: 10/662,593

(22) Filed: Sep. 15, 2003

(51) Int. Cl. B25B 13/04

(52) U.S. Cl. 81/120

(57) ABSTRACT

A cap for a filter includes an interior filter-contacting surface which frictionally engages an outer surface of the filter. Opposed to the interior surface is an exterior gripping surface having an average surface roughness ranging between about 0.025 mm and about 4.6 mm (peak to valley).

### BACKGROUND OF THE INVENTION

The present invention relates generally to filters, and more particularly to a filter cap having a gripping surface.

One type of filter, useful in automotive internal combustion engines, is a spin-on filter. Spin-on filters have a generally tubular geometry with inlet and outlet orifices at one end of the body to allow for a flow of liquid. The orifices generally reside on a plate at the top of the filter. The plate is encircled by a gasket, which provides a fluid seal when mated with a flange associated with the engine.

A spin-on filter is installed into an area of an engine that offers generally a small amount of clearance; hence the standard method of insertion and removal usually utilizes no tools. Further, if tools are used during installation, the filter may become very difficult to remove and may require crushing or puncturing the filter for removal. Thus, to install or remove, the spin-on filter is normally rotated by hand until the gasket forms an adequate seal with, or is disengaged from, a flange associated with the engine. More specifically, during installation of the filter, the installer generally dips a finger in motor oil and runs that finger around the gasket for lubrication. The installer then rotates the filter until specified gasket compression is achieved, e.g. one full turn (half turn, quarter turn, etc.) after the gasket seats.

During operation, the heat of the engine may tend to cause the gasket to adhere to the sealing surface/flange, thereby requiring more torque to remove the filter for service than it took to install. This may be particularly true if the gasket is not adequately lubricated with oil upon installation.

Due to this, and due to the generally smooth outer surface of a spin-on filter, it is often difficult to attain the required grip to rotate the filter by hand to remove it. The generally smooth outer surface may also make it difficult to install the filter. This difficulty in installation and/or removal may often be multiplied by the presence of oil or other greasy materials on the outside of the spin-on filter or on the hands, further decreasing the available friction on the filter.

Insertion and removal of spin-on filters is a potentially frequent activity. Automotive professionals in the United States generally recommend that an automotive oil filter, one type of spin-on filter, should be replaced every 3,000 miles or every three months (whichever comes first). Such frequency of inserting and removing a spin-on filter magnifies the potentially aggravating effect of this activity. In some areas outside the United States, longer intervals may be found. However, such longer intervals can create their own problems regarding the difficulty of removing a spin-on filter, as greater amounts of oil or debris may accumulate on the surface of the filter.

Some attempts to ease the process of installing and removing spin-on filters have included a rough coating on the filter surface, an extendible handle, a specially designed wrench, bosses, and wings. However, these solutions require modifications to the filters themselves and/or require purchase of special tools. Such modifications to the filter itself are not re-usable and are still susceptible to contamination with oil and debris accumulation, and thus may add unnecessary cost to what should be a relatively inexpensive and routine undertaking.

### SUMMARY OF THE INVENTION

The present invention substantially solves the drawbacks enumerated above by providing a cap for a filter which includes an interior filter-contacting surface which frictionally engages an outer surface of the filter. Opposed to the interior surface is an exterior gripping surface having an average surface roughness ranging between about 0.025 mm and about 4.6 mm (peak to valley).

### BRIEF DESCRIPTION OF THE DRAWINGS

Objects, features and advantages of the present invention will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1 is an exploded perspective view of an oil filter and gasket showing an embodiment of the present invention exploded therefrom;

FIG. 2 is a cross-sectional front view of an embodiment of the present invention;

FIG. 2A is an enlarged, cutaway, cross-sectional view from FIG. 2 showing an embodiment of the surface roughness of the present invention;

FIG. 3 is a perspective view of an alternate embodiment of the present invention; and

FIG. 4 is an enlarged, cutaway, schematic view showing an alternate embodiment of the surface roughness of the present invention.

### DETAILED DESCRIPTION OF THE EMBODIMENTS

The present invention seeks to simplify the potentially burdensome task of installing and removing a filter such as, for example, a spin-on filter. The present invention advantageously requires no tools, which often are unusable because of typically low tool clearances around a filter; is relatively inexpensive and simple to produce; and generally works well with the existing conditions in which the task is usually performed. Further, the process of making the cap of the present invention generally does not require large capital expenditures.

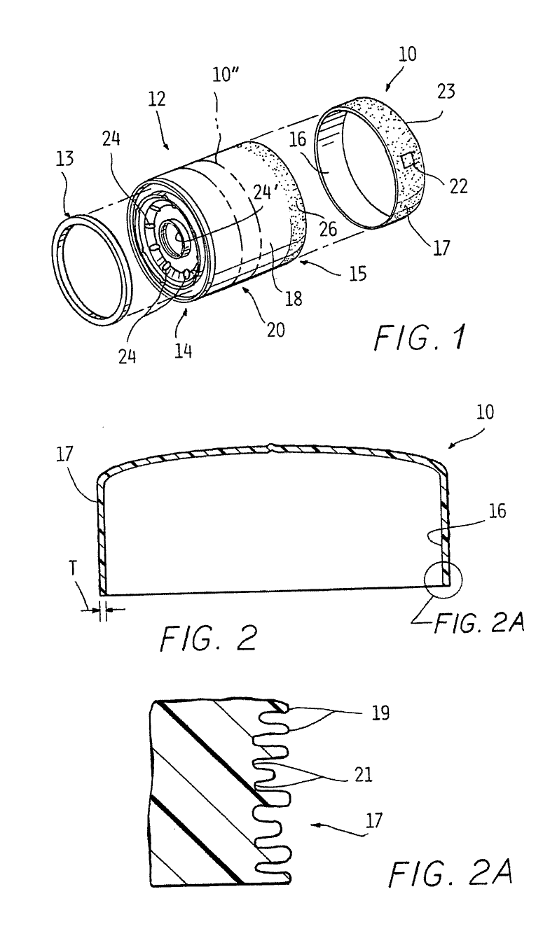

Referring now to FIG. 1, the cap of the present invention is designated generally as 10. The cap 10 is adapted to aid in tactile control of a spin-on filter 12 during installation and removal of the filter 12 in an engine (not shown).

The filter 12 has a gasket-receiving end region 14 which houses a gasket 13, and an end region 15 distal to the gasket-receiving end region 14. The gasket 13 aids in providing an adequate seal between the filter 12 and the engine. When a spin-on filter 12 is in use, for example, an automotive oil filter, an automobile's oil enters and exits the filter 12 through openings 24, 24′ operatively disposed in the gasket-receiving end region 14 of the filter 12. The gasket 13 aids in substantially preventing leakage of liquid or gas into or out of the filter 12, which leakage may in some instances deleteriously affect the ability of the filter 12 to efficiently filter a vehicle's oil.

Cap 10 has an interior filter-contacting surface 16, which receives at least a portion of the distal end region 15. An exterior gripping surface 17 is opposed to the interior filter-contacting surface 16. The interior filter-contacting surface 16 frictionally engages an outer surface 18 of the filter 12 in either a permanent, semi-permanent, or releasable manner. It is to be understood that cap 10 may be formed such that filter-contacting surface 16 and exterior gripping surface 17 may be installed on filter 12 at any suitable location, including the mid-section 20 of filter 12, and/or closer to gasket-receiving end region 14. One non-limitative example of such an alternate embodiment is shown in phantom in FIG. 1 wherein cap 10″ has a generally tubular configuration.

The mating between the cap 10, 10′ (described hereinbelow), 10″ and the filter 12 causes cap 10, 10′, 10″ and filter 12 to substantially react as a single body to a rotational force applied to the exterior gripping surface 17, as is present during installation and removal of a filter 12 in an engine. In an embodiment of the cap 10, 10′, 10″ where the cap is affixed to the filter 12 in a semi-permanent or releasable manner, the cap 10, 10′, 10″ may be removed from the filter 12 by any suitable means, such as for example, by lifting the cap 10, 10′, 10″ from the filter 12 in a peeling fashion. Removing the cap 10, 10′, 10″ in this manner may advantageously allow a consumer to reuse the cap 10, 10′, 10″ on another filter 12, if desired.

In an embodiment of the present invention, the cap 10, 10″ is pre-formed such that its manufacture is completed prior to introduction to and mating with the filter 12. One non-limitative example of a suitable manufacturing process utilizes a mandrel (not shown) fabricated to a desired size and shape suitable for the cap 10, 10″ of the present invention. The mandrel is dipped into a selected melted, liquid material, which forms the desired shape of the cap 10, 10″. The mandrel is dipped one or more times, as desired, to build up an appropriate thickness T (the thickness T may be seen in FIG. 2), such as for example, between about 0.79 millimeters (0.031 inches) and about 2.38 millimeters (0.094 inches). An appropriate thickness is that which is thick enough to provide a sturdy geometry to the cap 10, 10″ to aid in durability during use, but thin enough to prevent excess bulk, which could be cumbersome and difficult to navigate within close proximity of the engine, and also thin enough to keep manufacturing costs and weight to a minimum.

Upon cooling and/or curing, the exterior gripping surface 17 may be modified to create a desired surface roughness. Without being bound to any theory, it is believed that this surface roughness forms the geometry from which the exterior gripping surface 17 derives the gripping capability. After the cap 10, 10″ is sufficiently hardened, it is stripped off the mandrel, and may then be installed on a filter 12 in due course. It is to be understood that other forms of manufacturing which produce embodiment(s) of cap 10, 10″ are contemplated as being within the scope of the present invention.

As may be seen in FIGS. 2A and 4, the exterior gripping surface 17 may have a surface roughness ranging from micro roughness to macro roughness. In the micro roughness range, gripping surface 17 may derive its gripping ability through its external surface roughness formed by a plurality of asperities, such as for example, peaks 19 and valleys 21. The exterior gripping surface 17 may have an average surface roughness ranging between about 0.025 millimeters (0.00098 inches) and about 1.14 millimeters (0.045 inches); or the average surface roughness may range between about 0.13 millimeters (0.005 inches) and about 0.76 millimeters (0.03 inches). In an alternate embodiment, the average surface roughness for the exterior gripping surface 17 ranges between about 0.25 millimeters (0.01 inches) and about 0.38 millimeters (0.015 inches).

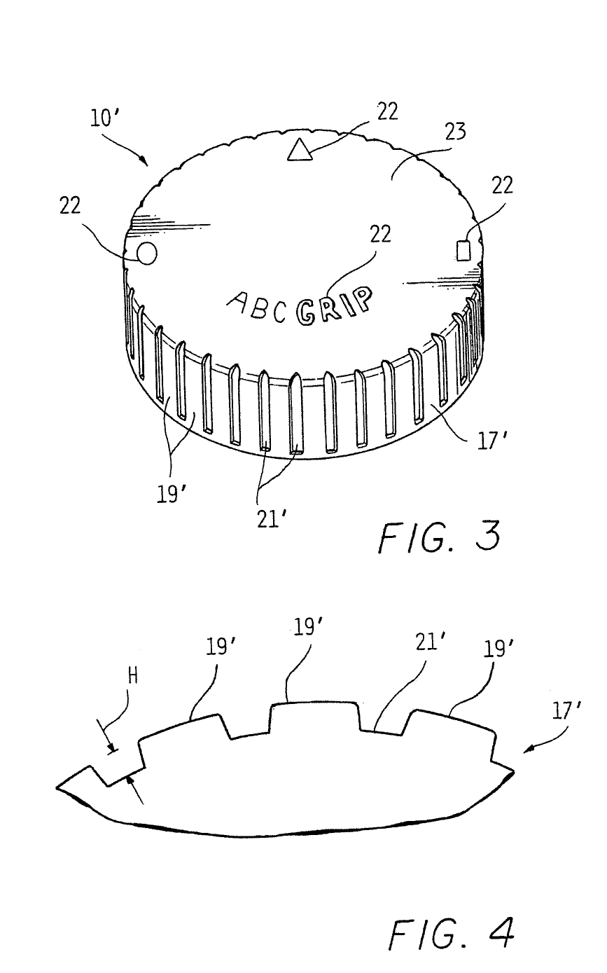

In an alternate embodiment of the cap 10′, as seen in FIG. 3 and FIG. 4, the surface roughness is a macro roughness. In this embodiment, the peaks 19′ are generally spline-shaped members, wherein the number of peaks 19′ ranges between about 2 and about 96. It is to be understood that in this embodiment relating to macro roughness, the definition of surface roughness is the height H of a spline/peak 19′ (see FIG. 4). The valleys between splines 19′ are designated 21′.

For this embodiment of the cap 10′, a non-inclusive list of manufacturing methods includes blow molding, injection molding, and/or the like. Other forms of manufacture that render the cap 10 according to embodiment(s) of the present invention are also contemplated as being within the purview of the present invention.

The average (macro) surface roughness (as defined herein) in this alternate embodiment ranges between about 0.51 millimeters (0.02 inches) and about 4.57 millimeters (0.18 inches); or alternately between about 0.76 millimeters (0.03 inches) and about 3.048 millimeters (0.12 inches). In a further alternate embodiment, the surface roughness ranges between about 1.016 millimeters (0.04 inches) and about 2.29 millimeters (0.09 inches). In yet a further embodiment, the surface roughness is about 1.52 millimeters (0.06 inches).

The composition of the cap 10, 10′, 10″ may be homogeneous, and/or it may be formed from a heterogeneous composition. In an embodiment of the present invention, cap 10 is formed from a polymeric material. This polymeric material may be a thermoplastic material, a non-limitative example of which is polyvinyl chloride (PVC). The polymeric material may also be a thermoset material. Natural or synthetic rubbers may also be suitable materials for cap 10, 10′, 10″. It is believed that these types of materials tend to have the characteristics that may be suitable to achieve the desired objective of aiding in tactile control of a filter 12 in accordance with embodiment(s) of the present invention. The materials should be flexible enough to frictionally engage and secure the cap 10, 10′, 10″ to the filter 12 during installation and/or removal of the filter 12 in an engine. The materials should also be durable enough to withstand the environment for which it is adapted, e.g. in very close proximity of an automotive engine (and automotive fluids), in an automotive garage, and on the road. For example, the cap 10, 10′, 10″ should be durable enough to withstand being struck by road debris. Further, cap 10, 10′, 10″ may desirably be durable enough to withstand exposure to potentially harsh chemical environments such as, for example, salt, oil, fuel, antifreeze, brake fluid, cleaning agents, engine degreasers, steam cleaners, and the like. It may also be desirable to form a cap 10 from a relatively inexpensive material to decrease manufacturing expenses.

It is to be understood that there may be various means to increase the surface roughness of the material from which the cap 10, 10′, 10″ is formed. Such treatments include, but are not limited to mechanical surface roughening for thermoset composites (for example), and more intricate chemical treatments for thermoplastics (for example). Methods for the surface modification of thermoset materials typically include mechanical means to achieve a rough surface. Such physical modification methods include, but are not limited to using sandpaper, sand blasting, utilizing tear ply or peel ply techniques, and the like. The methods typically used to modify the surfaces of thermoplastic materials may be chemical-based means, including but not limited to plasma treatment, oxidizing flame treatments, laser treatments, and the like. Further, an additive(s) may be added to the material to substantially prevent cap 10 from forming a smooth outer surface. Each of these methods generally alters the surface chemistry of the thermoplastic materials to enhance the material properties.

It is to be understood that the cap 10 is adapted to be installed/removed either manually or via an automated mechanism, and/or with or without tools. The current trend in installing and removing spin-on filters 12 is to manually perform the act using few or no tools. It is believed that the presently available tools to aid in exchanging a spin-on filter 12 are generally not adequate. However, it is foreseeable that the process of installation and removal of filters 12 may become a largely automated process rather than the current largely manual operation, and it is within the purview of the present invention that cap 10 will satisfactorily function with various forms of installation and removal of filters 12.

It is to be understood that the cap 10 may be reused if desired, or it may be disposed of after a single use. The cost to manufacture a cap 10 is projected to be relatively economical, such that it may be feasible to dispose of each cap 10 after only one use (for example after the life of one filter 12, including one installation and one removal from an engine). However, it is also foreseeable that one may choose to reuse a cap 10 by removing it from a used filter 12 and installing it on a new filter 12.

The cap 10, 10′, 10″ may optionally include an orientation portion 22 adapted for visual and/or non-visual/tactile orientation during insertion or removal of the filter 12 in an engine. The orientation portion(s) 22 may include, but are not limited to raised and/or embossed indicia, varied coloring, non-embossed indicia, and the like. Orientation portion 22 enables a user to orient himself with the position of the cap 10, 10′, 10″ (and thus, the filter 12) and may facilitate non-visual and/or visual use of the cap 10 for positional orientation during installation and removal of the filter 12. This may be useful when changing a spin-on filter 12 in many cars since the filter 12 is generally located in an area that may not be effectively visible, therefore non-visual cues may be an aid for installing and removing the filter 12. Further, by noting the position of orientation member 22 at the beginning of installation, member 22 may aid in orientation of filter 12 by alerting the user (visually and/or non-visually) via its changed position during installation as to the portion of/number of turn(s) accomplished-this may be helpful in achieving a desired gasket 13 compression. It is to be understood that the orientation portion 22 may be disposed on/in any suitable area of the cap 10, 10′, 10″, some non-limitative examples of which include in/on the circular exterior face 23 of cap 10, 10′ (as shown in FIG. 3), and/or in/on the exterior gripping surface 17 (as shown in FIG. 1).

The portion of the distal end region 15 over which the cap 10 aligns may optionally have a rough exterior surface 26. This rough surface 26 may be integrated into the material that makes up the exterior surface 18 of the filter 12, and/or it 26 may be applied to the exterior surface 18. Rough surface 26 may desirably increase the grip between the interior filter-contacting surface 16 of the cap 10, 10′, 10″ and the exterior surface 18 of the filter 12. This may in some instances be desirable to aid in preventing or reducing potential relative slippage between the interior filter-contacting surface 16 of the cap 10, 10′, 10″ and the exterior surface 18 of the filter 12.

It is also contemplated as being within the purview of the present invention that other means, such as heat treatment, adhesives, and the like, may be used to increase the effective friction such that a substantially permanent bond is formed between the interior filter-contacting surface 16 of the cap 10 and the exterior surface 18 of the filter 12.

It is to be understood that cap 10 may also be adapted to provide an enhanced grip on devices other than filter 12.

While several embodiments of the invention have been described in detail, it will be apparent to those skilled in the art that the disclosed embodiments may be modified. Therefore, the foregoing description is to be considered exemplary rather than limiting, and the true scope of the invention is that defined in the following claims.

1. A cap for a filter, comprising:
an interior filter-contacting surface adapted to frictionally engage an outer surface of the filter; and
an exterior gripping surface, opposed to the interior filter-contacting surface, the exterior gripping surface having an average surface roughness ranging between about 0.025 millimeters (0.00098 inches) to about 4.57 millimeters (0.18 inches) (peak to valley).

2. The cap as defined in claim 1 wherein the filter is a spin-on filter having a gasket-receiving end region and an end region distal to the gasket-receiving end region, and wherein the cap is adapted for use on the spin-on filter.

3. The cap as defined in claim 2 wherein the interior filter-contacting surface aligns over at least a portion of the distal end region.

4. The cap as defined in claim 1 wherein the filter is a spin-on filter having a gasket-receiving end region and an end region distal to the gasket-receiving end region, and wherein the cap is adapted to be disposed on the filter outer surface at an area intermediate the gasket-receiving end region and the distal end region.

5. The cap as defined in claim 1 wherein the cap is pre-formed.

6. The cap as defined in claim 1 wherein the average surface roughness (peak to valley) ranges between about 0.51 millimeters (0.02 inches) and about 4.57 millimeters (0.18 inches).

7. The cap as defined in claim 1 wherein the average surface roughness (peak to valley) ranges between about 0.76 millimeters (0.03 inches) and about 3.048 millimeters (0.12 inches).

8. The cap as defined in claim 1 wherein the average surface roughness (peak to valley) ranges between about 1.016 millimeters (0.04 inches) and about 2.29 millimeters (0.09 inches).

9. The cap as defined in claim 1 wherein the average surface roughness (peak to valley) ranges between about 0.025 millimeters (0.00098 inches) and about 1.14 millimeters (0.045 inches).

10. The cap as defined in claim 1 wherein the average surface roughness (peak to valley) ranges between about 0.13 millimeters (0.005 inches) and about 0.76 millimeters (0.03 inches).

11. The cap as defined in claim 1 wherein the average surface roughness (peak to valley) ranges between about 0.25 millimeters (0.01 inches) and about 0.38 millimeters (0.015 inches).

12. The cap as defined in claim 1 wherein the average surface roughness (peak to valley) is about 1.52 millimeters (0.06 inches).

13. The cap as defined in claim 1 wherein each of the peaks is generally a spline-shaped member; and wherein the number of peaks ranges between about 2 and about 96.

14. The cap as defined in claim 1 wherein the cap is formed from a polymeric material.

15. The cap as defined in claim 14 wherein the polymeric material is a thermoplastic material.

16. The cap as defined in claim 15 wherein the polymeric material is polyvinyl chloride (PVC).

17. The cap as defined in claim 14 wherein the cap is formed from a thermoset material.

18. The cap as defined in claim 17 wherein the thermoset material is a rubber material.

19. The cap as defined in claim 1 wherein the cap is adapted for single-use.

20. The cap as defined in claim 1 wherein the cap is adapted to be reusable.

21. The cap as defined in claim 1 wherein the exterior gripping surface aids in tactile control of the filter during insertion and removal of the filter in an automotive internal combustion engine.

22. The cap as defined in claim 1 wherein the filter is adapted to be manually inserted or removed in an engine.

23. The cap as defined in claim 1 wherein the filter is adapted to be automatically inserted or removed in an engine.

24. The cap as defined in claim 1, further comprising an orientation portion adapted to aid in filter orientation with respect to the engine during at least one of insertion and removal of the filter.

25. The cap as defined in claim 1 wherein the interior filter-contacting surface is adapted to be substantially bonded to the outer surface of the filter.

26. The cap as defined in claim 1 wherein the cap is adapted to be removable from the outer surface of the filter.

27. A cap for a spin-on filter having a gasket-receiving end region and an end region distal to the gasket-receiving end region, the cap comprising:
an interior, filter-contacting surface, wherein the filter-contacting surface is adapted to be received over at least a portion of, and to frictionally engage an outer surface of the distal end region of the filter; and
an exterior gripping surface, opposed to the interior filter-contacting surface, the gripping surface having an average surface roughness of about 0.025 millimeters (0.00098 inches) to about 4.57 millimeters (0.18 inches) (peak to valley);
wherein the cap is formed from a polymeric material, and wherein the exterior gripping surface aids in tactile control of the filter during at least one of installation and removal of the filter in an automotive internal combustion engine.

28. The cap as defined in claim 27 wherein the average surface roughness (peak to valley) ranges between about 0.76 millimeters (0.03 inches) and about 3.048 millimeters (0.12 inches).

29. The cap as defined in claim 27 wherein the average surface roughness (peak to valley) ranges between about 0.13 millimeters (0.005 inches) and about 0.76 millimeters (0.03 inches).

30. The cap as defined in claim 27 wherein each of the peaks is generally a spline-shaped member, and wherein the number of peaks ranges between about 2 and about 96.

31. The cap as defined in claim 27, further comprising an orientation portion adapted to aid in filter orientation with respect to the engine during at least one of insertion and removal of the filter.

32. A spin-on filter, comprising:
an outer surface; and
a cap, comprising:
an interior, filter-contacting surface adapted to frictionally engage the outer surface of the filter; and
an exterior gripping surface, opposed to the interior filter-contacting surface, the gripping surface having an average surface roughness ranging between about 0.025 millimeters (0.00098 inches) and about 4.57 millimeters (0.18 inches) (peak to valley).
